(19) United States
(12) Patent Application Publication
(10) Pub. No.: US 2009/0316109 A1
(43) Pub. Date: Dec. 24, 2009

(54) MODULAR RETAINER AND COUPLING SYSTEM AND METHOD OF USE

(76) Inventor: Karl Hellberg, Logan, UT (US)

Correspondence Address: J. Todd Rushton, 1040 Bountiful Blvd., Bountiful, UT, 84010, US

(21) Appl. No.: 12/467,409

(22) Filed: May 18, 2009

Related U.S. Application Data
(60) Provisional application No. 61/074,508, filed on Jun. 20, 2008.

(51) Int. Cl. G02C 11/00

(52) U.S. Cl. 351/157

(57) ABSTRACT

A modular retainer and decorative coupling system with interchangeable components used to form accessories including eyeglass retainers, lanyards, necklaces, wristbands, bracelets and hair ornaments. The modular coupling and eyeglass retainer system includes an elongate cord having an attachment portion on each end, a plurality of shorter cords, each having an attachment portion on each end, a plurality of interchangeable eyeglass frame couplers, a plurality of inter-coupler members and a medial connection device. The modular system components can be releasably coupled in various intercoupling schemes including, various eyeglass retainer configurations that accommodate a wide variety of eyeglass frame dimensions, and closed loop configurations, such as lanyards, necklaces, bracelets, wristbands and anklets.

The present application relates to Provisional Application 61/074,508 filed, Jun. 20, 2008, and claims priority therefrom under 35 U.S.C. 119(e).

### BACKGROUND OF THE INVENTION

The present invention relates generally to a modular retainer and decorative system for an adornment accessory or coupling for an adornment accessory. In particular, this disclosure relates to systems of interchangeable components for use in accessorizing a person, and for use with eyeglass retainers, lanyards, necklaces, wristbands, bracelets, anklets, hair ornaments and similar accessories.

Coupling systems connect components for purposes of securing the components together and may provide additional functionality for decorative and information purposes. Necklaces are coupled or clasped together allowing the user to easily put on or remove the necklace. Numerous clasp-type necklace coupling systems are known in the jewelry field. These coupling systems include clasps, hooks, t-locks, etc.

Eyeglasses are often coupled with a retainer system, to provide ease of access when removed, to prevent loss or damage and to secure the eyeglasses during vigorous activity such as physical fitness or sports. Various coupling techniques are used to couple the retainer systems to the frame portion of the eyeglasses; including, sleeves, loops or clasps.

One of the shortcomings with conventional coupling and retainer systems are their limited adjustability and accommodation for engaging a wide variety of components. For example, eyeglass retainers are generally limited to accommodating a small variety of frame sizes, despite the large variety in frame shapes and thicknesses among modern eyeglasses. Likewise, the efficient fitting of lanyards, bracelets and necklaces are limited to users of a certain build or size. Manufacturers and retailers are therefore, forced to produce and sell a wide variety similar items, with slightly different couplings and in a wide variety of sizes. This is undesirable from both a manufacturing and retail perspective. This lack of accommodation prevents users from making impulsive purchases by requiring them to specifically analyze whether their eyeglasses fit a particular retainer system or whether a bracelet, necklace or lanyard will fit them properly. This problem is enhanced when the purchase of fit-specific merchandise is intended as a gift for another person whose size is not known or when the person is not readily available.

Another problem with conventional coupling and retainer system includes their end manufacture component product applicability. In general, the components for an eyeglass retainer will only function as an eyeglass retainer and therefore must be sold for use as an eyeglass retainer. Likewise, conventional lanyards, necklaces and bracelets are also limited in their product applicability. This limited applicability requires additional manufacturing resources and more accurate consumption predictions by both manufactures and retailers.

Therefore, there is a need in the industry for a modular retainer and coupling system that overcomes the limitations and inefficiencies of the previously available devices.

### SUMMARY OF THE INVENTION

This disclosure relates to modular retainer and decorative coupling systems. In particular, this disclosure relates to systems and methods for use with interchangeable components in forming accessories including eyeglass retainers, lanyards, necklaces, wristbands, bracelets, hair ornaments and so forth.

One embodiment relates to a modular coupling and eyeglass retainer system including at least one elongate cord, a plurality of shorter cords, a plurality of interchangeable eyeglass frame couplers, a plurality of inter-coupler members and a medial connection device. The modular system components can be releasably coupled in various intercoupling schemes including, various eyeglass retainer configurations, that accommodate a wide variety of eyeglass frame dimensions, and closed loop configurations, such as lanyards, necklaces, bracelets, wristbands and anklets. The eyeglass retainer configurations include coupling the ends of the cord to one of the interchangeable eyeglass frame couplers via the inter-coupler members. The closed loop configurations include coupling the ends of one or more cords via the inter-coupler members.

In one embodiment of the retainer system, each end of the cord and each end of the at least another cord has an attachment portion. The attachment portion may be a hole, loop or eye formed integral with, and formed from a material homogenous with, the cords. The hole, loop or eye may be shaped as an oval, circle, rectangular or have a generally square configuration. In another embodiment, the attachment portion can be a hole, loop or eye formed using a material different from the material used for the cords. The hole, loop or eye may be fused, adhesively attached or mechanically attached to the ends of the cord.

In one embodiment, the plurality of interchangeable eyeglass frame couplers includes an attachment portion configured as a hole, loop or eye. The hole, loop or eye may be formed integral with, and formed from a material homogenous with, the frame couplers. The hole, loop or eye in the frame couplers substantially match the hole, loop or eye formed in the ends of the cords. The hole, loop or eye in the frame couplers may be shaped as an oval, circle, rectangular or have a generally square configuration. In another embodiment, the attachment portion of the frame couplers can be a hole, loop or eye formed using a material different from the material used for the frame couplers. The hole, loop or eye may be fused, adhesively attached or mechanically attached to ends of the frame couplers.

One embodiment, of the retainer system may include a plurality of inter-coupler members. The inter-coupler members may be used to attach the components of the retainer system together. In one embodiment, the inter-coupler members are configured as a stylized s-hook, composed of resilient material wherein, when a portion of the s-hook is deformed it will return to the original shape. Component coupling may be accomplished by inserting the attachment portion of a cord or the attachment portion of a frame coupler into a first side of the s-hook and inserting another attachment portion into a second side of the s-hook. The open sides of the s-hook may be barbed, turned in toward the center, or otherwise configured, to sufficiently retain the attachment portion of the retainer system components. In another embodiment, the inter-couplers are configured as a c-clip, with a narrow central gap. The c-clip is composed of resilient material wherein, when the legs of the c-clip are deformed to open the central gap, the c-clip will return to the original position when the pressure is released. Component coupling is accomplished by inserting the attachment portion of a cord or frame coupler into the c-clip. In yet another embodiment, the inter-couplers are configured as snaps or pins having opposing retainer heads and an interlocking central post. The retainer heads are configured such that they are larger than the hole, loop or eye of the attachment portions. The retainer head may be any shape, including round, square, triangular, ball, cube or may be configured an object for ornamentation. The interlocking central post may engage using any method known in the art of snap pins, such as, ball and socket, slip-ring and groove, barb and groove or a protuberant with corresponding slot. Component coupling may be accomplished by aligning the attachment portions of one or more components, inserting the interlocking center post through the hole, loop or eye of the attachment portions, and snapping a corresponding retainer head onto the central post.

In one embodiment, the frame couplers may be attached to the flexible cord using a simple loop to loop connection, eliminating the need for an inter-coupler member. The attachment end of the frame coupler may inserted through the attachment end of the cord, the coupling end of the frame coupler may then be pushed through the hole, loop or eye of its own attachment end and pulled tight.

One embodiment of a retainer system may include a flexible cord having an attachment portion on each end. In one embodiment, the attachment portion may be configured with an opening for receiving a protrusion in a male to female relationship. The receiving portion having a first shape to accept the protrusion; when the protrusion is pressed into the receiving portion, the receiving portion assumes a second shape to retain the protrusion. In another embodiment, the attachment portion may be configured with a protrusion for inserting into a corresponding opening in a male to female relationship. The receiving portion having a first shape to accept the protrusion; when the protrusion is pressed into the receiving portion, the receiving portion assumes a second shape to retain the protrusion.

In one embodiment of the retainer system, the frame coupler has an attachment portion configured in a male female relationship. In one embodiment, the attachment portion is configured as a receiver for acceptance of a corresponding protrusion. In another embodiment, the attachment portion is configured as a protrusion for insertion into a corresponding receiver.

In another embodiment, the attachment portion of the cord and or the frame coupler is a girth-hitch, or one of a knob and corresponding loop. The knob is a first size and the corresponding loop, formed using a compliant material, is a second size, smaller than the knob. Attachment of the components is accomplished by pressing the knob through the corresponding loop. The knob may be an alternate shape such as sphere, hemisphere, disc, cube, square, or an ornamental shape.

In one embodiment, the modular coupling and eyeglass retainer system includes a medial connecting device for use of ornamentation or to adjust the length or tension in lanyard or eyeglass retainer. The medial connecting device is configured to receive both ends of a cord, forming a closed loop on one side of the connecting device and the tag ends protruding from the second side. The tag ends may be attached directly together forming a lanyard or may be fitted with frame couplers and attached to a pair of eyeglasses. The length of the lanyard or eyeglass retainer can be adjusted by moving the medial connecting device closer to, or further from, the tag ends of the cord. The eyeglass retainer can be tensioned when worn by a user, by simply sliding the medial connection device up the cord and against the back of the user's head.

In one embodiment, the medial connection device is attached to the cord by inserting the tag ends of the cord into receiving holes in the back the connection device. In another embodiment, the medial connection device includes one or more clips composed of a resilient material. The open end of the clip can be deformed to receive a portion of the elongate cord. In another embodiment, the medial connection device may be configured as two corresponding halves that are snapped into position over the elongate cord.

The medial connection device can be formed in simple or complex shapes and used for ornamentation or information. Shapes contemplated include, disc, hemisphere, square, triangle, arrowhead, tiger, alligator, butterfly, bow etc. In one embodiment, the medial connection device can be attached to a clasp or barrette for hair ornamentation.

In one embodiment, the modular coupling and eyeglass retainer system including, an elongate cord, at least another cord, a plurality of interchangeable eyeglass frame couplers, a plurality of inter-coupler members and a medial connection device.

When creating an eyeglass retainer using the system, the user selects an appropriate cord or a cord that comfortably fits over the user's head and then selects the appropriate frame couplers. The frame couplers are secured to the attachment portion of the flexible cord using inter-coupler members. A medial connection device may be secured onto the flexible cord, providing adjustability for the eyeglass retainer. The method of attachment between the eyeglass retainer and the eyeglasses is dictated by, the user's preference, frame style and type of frame couple selected from the plurality of frame couplers. The user may desire to attach the eyeglass retainer forward on the temple shaft using a tensioned loop or o-ring connection, allowing the eyeglass retainer to hang in front of the user's ears. The eyeglass retainer may also be attached to the end of the temple earpiece using slip-on sleeve coupling, in this position the eyeglass retainer will hang behind the user's ears. The plurality of frame couplers includes sleeve type frame couplers in a variety of sizes to accommodate the various ear piece sizes available on modern eyeglasses.

A lanyard can be created by selecting a flexible cord of an appropriate length to fit over the user's head. Various items, such an ID tag, a security card, keys or an ornament can be slid onto the flexible cord. The attachment portions of the flexible cord are attached together using an inter-coupler member. If the user desires an adjustable lanyard, a medial connection device is added into the system. If the user simply desires a longer lanyard, one or more of the plurality of flexible cords may be added into the lanyard using one or more additional inter-coupler members.

A bracelet or anklet can be formed by selecting a flexible cord having an appropriate length to comfortably encircle the user's wrist or ankle, and securing the attachment portion with an inter-coupler member.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set forth hereinafter.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 illustrates an exploded view of a modular coupling and eyeglass retainer system in accordance with one embodiment of the disclosure;

FIG. 2 illustrates an exploded view of an eyeglass retainer in accordance with one embodiment of the disclosure;

FIG. 3 illustrates one embodiment of an eyeglass retainer attached to eyeglasses;

FIG. 4 illustrates one embodiment of an eyeglass retainer worn by a user;

FIG. 5 illustrates one embodiment of a lanyard;

FIG. 6 illustrates one embodiment of a necklace;

FIGS. 7A and 7B illustrate embodiments of an attachment portion;

FIG. 8 illustrates embodiments of inter-coupler members;

FIG. 9 illustrates other embodiments of inter-coupler members;

FIG. 10 illustrates embodiments of frame couplers;

FIG. 11 illustrates embodiments of frame couplers; and

FIG. 12 illustrates embodiments of a medial connection device.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with definitions set out below. As used herein, the terms “comprising,” “including,” “containing,” “characterized by.” and the grammatical equivalents thereof are inclusive or open-ended terms that do not exclude additional, unrecited elements or method processes.

The disclosure relates to modular retainer and decorative coupling systems. In particular, the disclosure relates to systems and methods of use for interchangeable components used in forming accessories including, eyeglass retainers, lanyards, wristbands, anklets, bracelets, necklaces, hair ornaments and so forth.

One embodiment of the disclosure relates to a modular coupling and eyeglass retainer system including, an elongate cord, at least another cord, a plurality of interchangeable eyeglass frame couplers, a plurality of inter-coupler members, and a medial connection device. The modular system components can be releasably coupled in various intercoupling schemes including, various eyeglass retainer configurations, that accommodate a wide variety of eyeglass frame dimensions and methods of attachment, and closed loop configurations such as lanyards, necklaces, wristbands, bracelets, and anklets. The eyeglass retainer configurations include coupling the ends of the cord to one of the interchangeable eyeglass frame couplers via the inter-coupler members. The closed loop configurations include coupling the ends of one or more cords to each other via the inter-coupler members.

One embodiment of the disclosure relates to a modular eyeglass retainer system including an elongate cord and a plurality of interchangeable eyeglass frame couplers. In another embodiment, the ends of the elongate cord are directly releasably coupled to the interchangeable eyeglass frame couplers using two types of direct release coupling include girth hitch and keyed couplings. An embodiment of the disclosure relates to a method for releasably intercoupling components in a modular eyeglass retainer and coupling system. Also, while embodiments are described in reference to modular retainer and coupling system, it will be appreciated that the teachings of the disclosure are applicable to other areas.

A modular system may be a system of components in which the components can be assembled and/or releasably coupled together by a user to form various configurations.

A loop may be an enclosed elongated cord or piece of material.

An eyeglass earpiece is the portion of the eyeglass temple that directly engages the ear of the user for purposes of support and retention. Various cross-section thickness and shapes may be included in eyeglass frame earpieces.

An eyeglass retainer may be a device that may be releasably coupled to the frame of a pair of eyeglasses or sunglasses. An eyeglass retainer may be used to secure the eyeglasses during vigorous activities such as sports and to prevent inadvertent removal. Likewise, an eyeglass retainer may be used as a storage system, such that eyeglasses can be removed and hung from the user's neck while not in use.

A lanyard may be a closed loop of material including some form of coupling mechanism. For example, the closed loop portion of a lanyard may be positioned over the user's neck for purposes of security, storage and informational display.

A necklace may be a closed loop of material configured to be placed around a user's neck, primarily for ornamentation of the user.

A bracelet or anklet may be a closed loop of material configured to place around a user's wrist or ankle primarily for ornamentation of the user.

In-line coupling may be a coupling of two elongated structures in a lengthwise manner such that the elongated structures are substantially parallel to one another, as opposed to perpendicular coupling of elongated structures.

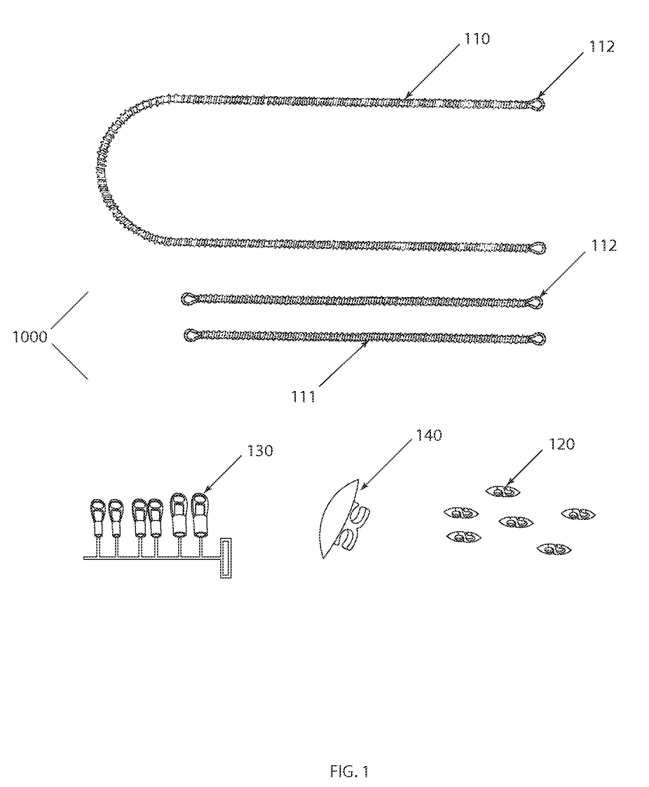

Illustrated in FIG. 1, is an exploded view of a modular retainer and coupling system 1000 in accordance with one embodiment of the disclosure. The modular retainer and coupling system 1000 includes, at least one cord 110 having coupling ends 112, two or more shorter cords 111, with coupling ends 112, a plurality of inter-coupler members 120, a medial connection device 140, and a plurality frame couplers 130. Frame couplers 130 are provided in a variety of sizes and configurations, allowing the user to determine the method of connection between the frame coupler 130 and the eyeglass earpiece and enabling the coupling system 1000 to accommodate eyeglasses having earpieces of varying shape and thickness.

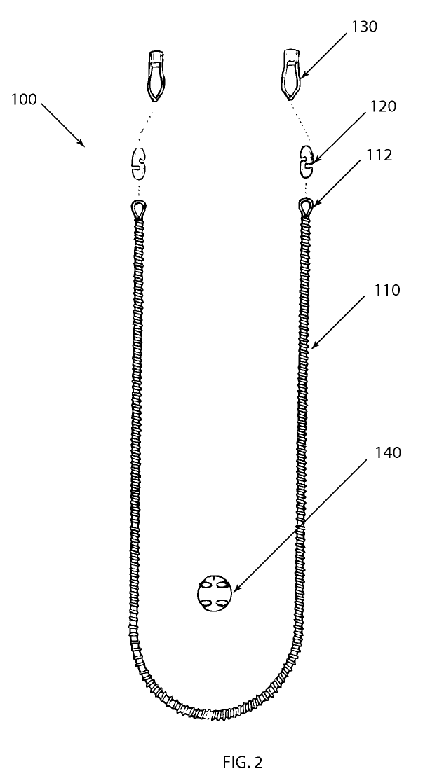

FIG. 2, is an exploded view of one embodiment of an eyeglass retainer 100 which can be assembled using the components of the modular retainer and coupling system 1000. Eyeglass retainer 100 includes, an elongate cord 110 having coupling ends 1112, inter-coupler members 120, frame couplers 130 and a medial connection device 140. The eyeglass retainer 100 is assembled by inserting the coupling end 112 into an opening of inter-coupler 120 and inserting the loop portion of the frame coupler 130 into the proper opening of inter-coupler 120 creating an inline connection. The second end of the eyeglass retainer 100 is assembled in the same fashion as the first end. The user may choose to attach a medial connection device 140 onto elongate cord 110, forming a closed loop.

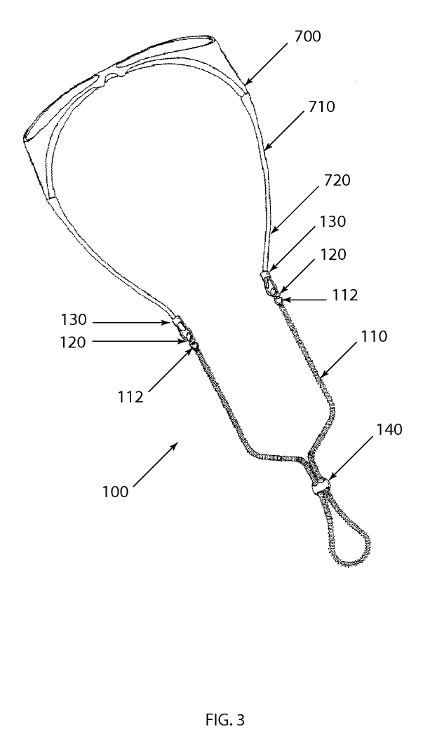

One embodiment, of eyeglass retainer 100 attached to eyeglasses 700 is shown and described in FIG. 3. The eyeglass retainer 100 composed of elongate cord 110, having coupling ends 112, inter-couplers 120, and frame couplers 130, is attached to the earpiece 720 of the eyeglass temple 710. As shown, elongate cord 110 extends away from the eyeglasses 700 parallel with the eyeglass temple 710. In another embodiment, frame coupler 130 is configured to attach to the eyeglass temple 710 allowing elongate cord 110 hang perpendicular with the temple 710. The medial connection device 140 can be moved along elongate cord 110 to adjust the functional length of the eyeglass retainer 100.

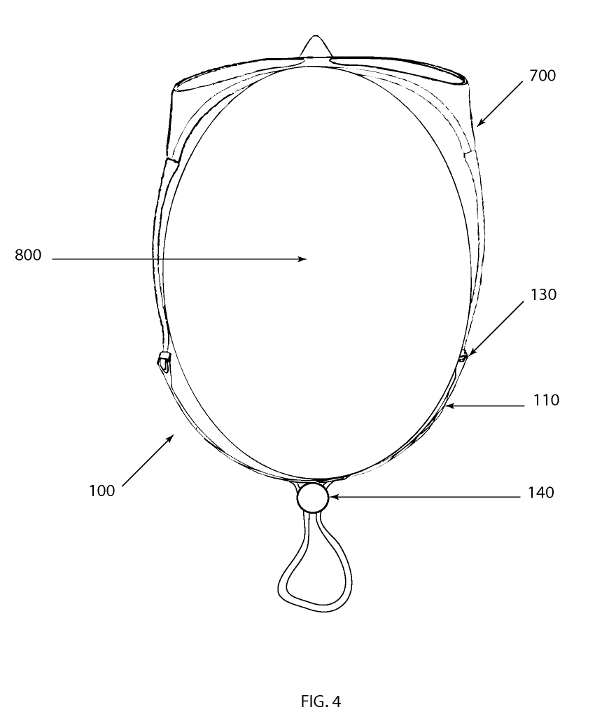

FIG. 4 describes a user 800 wearing one embodiment of eyeglass retainer 100 attached to eyeglasses 700. Eyeglass retainer 100 is attached to eyeglasses 700 in an inline fashion using frame couplers 130. The medial connection device 140 is slide forward against the back of the user's head, effectively securing eyeglasses 700.

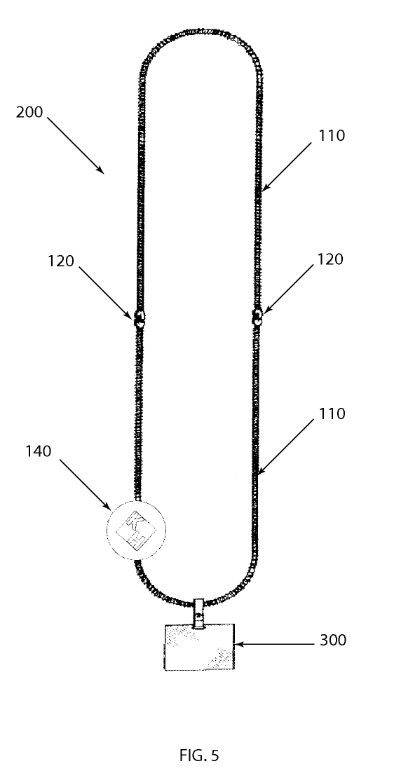

One embodiment, of the modular retainer and coupling system 1000 configured as a lanyard 200 is shown and described in FIG. 5. The lanyard 200 may be constructed by connecting more than one elongate cord 110 or an elongate cord 110 and one or more short cords 111 attached end to end, using inter-coupler members 120. Lanyard 200 can be used to display an informational placard or ID tag 300 or may be used to secure items such as magnetic ID cards, card keys or standard keys. Medial connection device 140 can be installed on one portion of elongate cord 110 for ornamentation or medial connection device 140 can be installed to form a closed loop, allowing the user to adjust where ID tag 300 or other selected items hang on the body.

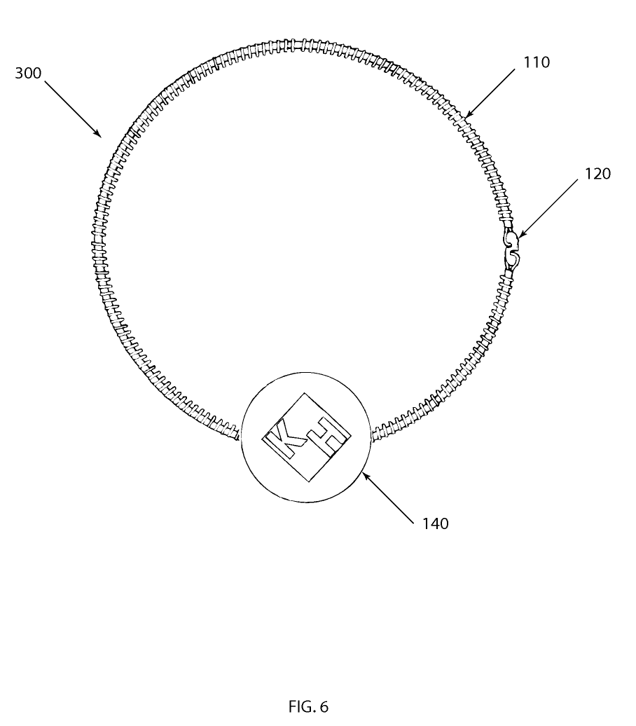

One embodiment, of the modular retainer and coupling system 1000 configured as a necklace 300 is shown and described in FIG. 6. Necklace 300 may be constructed by using the elongate cord 110 and inter-coupling member 120. If a longer necklace 300 is desired, a second elongate cord 110 or a shorter cord 111 may be coupled in using additional inter-coupling members 120. Medial connection device 140 may be attached or a pendant may be included for ornamentation. A bracelet or anklet may be assembled using a shorter cord 111 and inter-coupling member 120.

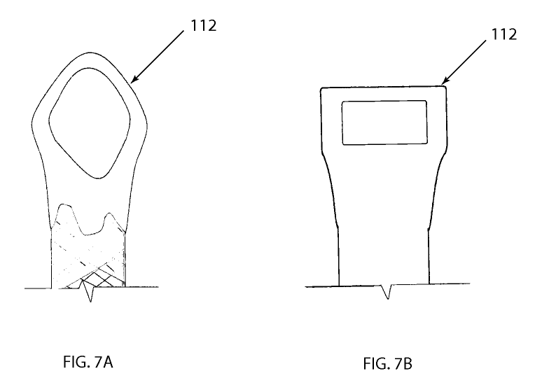

Coupling ends 112 may be configured as a circle, oval, square (FIG. 7B), rectangular, or another irregular shape as shown in FIG. 7A. The coupling ends 112 are designed for inline coupling of cord sections 110/111 or inline coupling of frame couplers 130, using inter-coupling members 120. Cord sections 110/111, and frame couplers 130 having a closed loop attachment, may be coupled together using a simple loop to loop connection (not shown).

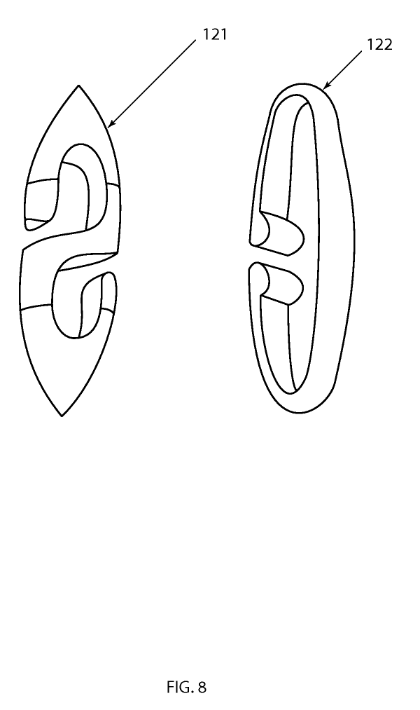

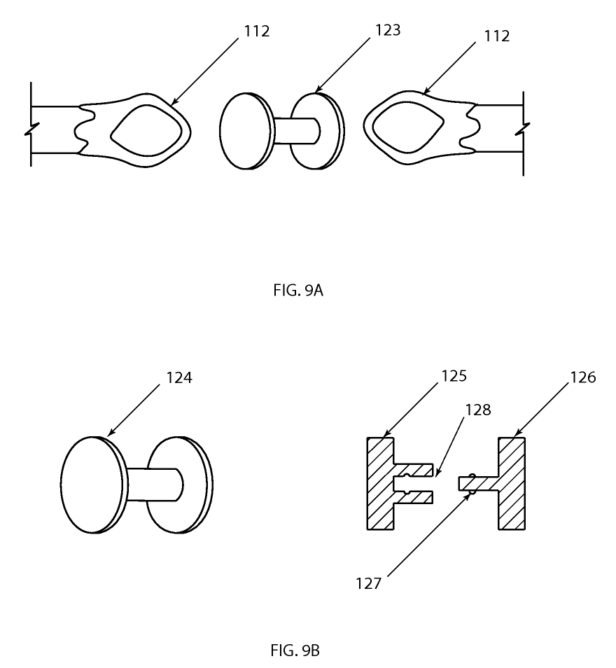

The inter-coupling members 120 of modular retainer and coupling system 1000 may be configured as an s-hook 121 or c-clip 122, as shown and described in FIG. 8. S-hook 121 and c-clip 122 are composed of a resilient material that deforms to allow the attachment portion 112 of cords 110/111 or of frame couplers 130 to be inserted into the opening. After the attachment the s-hook 121 or c-clip 122 will return to the original shape, securing the inserted attachment portion. Another embodiment of the inter-coupler 120 may be a stud or barbell 123, as shown and described in FIG. 9A. The barbell 123 has ends configured as a discs, balls, hemispheres, cubes or similar structures having and outside profile larger than the loop in the attachment portion 112 of cord 110/111 or the attachment portion of frame couplers 130. Connection is accomplished by stretching the attachment portion 112 of cords 110/111 or the attachment portion of frame couplers 130 over the ends of barbell 130. In yet another embodiment, of inter-coupler 120 may be stud or barbell 124 as shown and described in FIG. 9B. Stud or barbell 124 has ends configured as a discs, balls, hemispheres, cubes or similar structures having and outside profile larger than the loop in the attachment portion 112 of cord 110/111 or the attachment portion of frame couplers 130. Connection is accomplished by inserting a first half 125 of barbell 124 through the attachment portion 112 of cord 110/111 or the attachment portion of frame couplers 130 and inserting a second half 126 through from the opposite side. Stud or barbell 124 is releasably assembled by inserting pin 127 into the receiver portion 128.

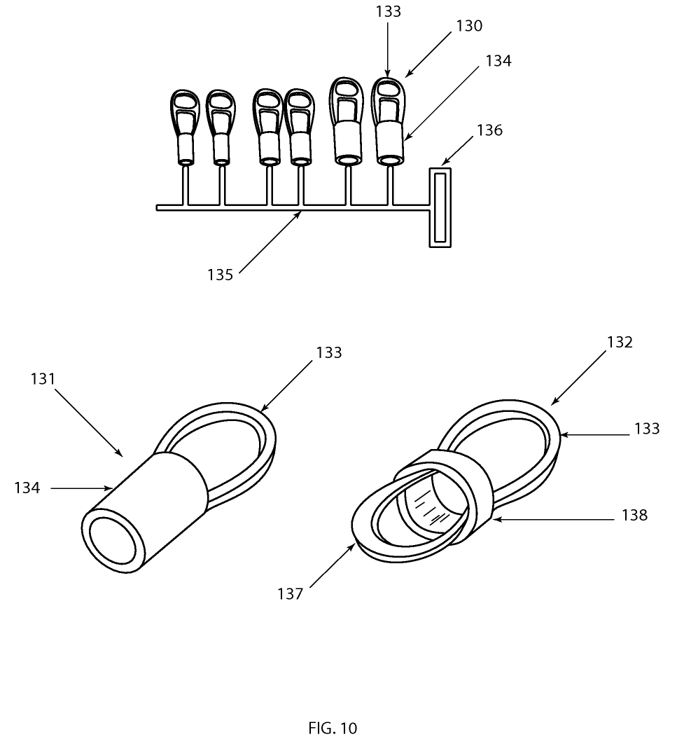

Frame couplers 130/131/132 of the modular retainer and coupling system 1000 are shown and described in FIG. 10. Frame coupler 130 is one embodiment of the invention. Frame coupler 130 includes an attachment portion 133 and frame coupling sleeve 134. Several sizes of frame coupling sleeve 134, such as small, medium and large, may be provided with the modular retainer and coupling system 1000. The different sizes allow for inline attachment between the frame coupling sleeve 134 and a variety of different eyeglass frame earpieces 720 (FIG. 3). Frame couplers 130 may remain attached to the injection mold sprue matrix 135, with packaging loop 136, for ease of handling and to prevent loss during distribution. In one embodiment, frame coupler 131 includes, an open elongated attachment portion 133 and a frame coupling sleeve 134. The elongated attachment portion 133 may be coupled to an elongated cord 110 using an inter-coupling member 120 or may be connected using a simple loop to loop connection. Frame coupler 132 is yet another embodiment. Frame coupler 132 may be used to connect the eyeglass retainer 100 (FIG. 2) directly to the eyeglass temple 710 (FIG. 3). Coupler 132 includes an attachment portion 133, temple coupling portion 137 and a tension band 138. The attachment portion 133 may be coupled with an elongated cord 110 using an inter-coupling member 120 or may be connected using a simple loop to loop connection. The temple coupling portion 137 may be slipped over the end of an eyeglass earpiece 720 and onto the eyeglass temple 710. Tension band 138 can be moved toward the temple coupling portion 137 to secure coupler 132 against the eyeglass temple 710. Coupler 132 attaches eyeglass retainer 100 perpendicular with eyeglass temple 710.

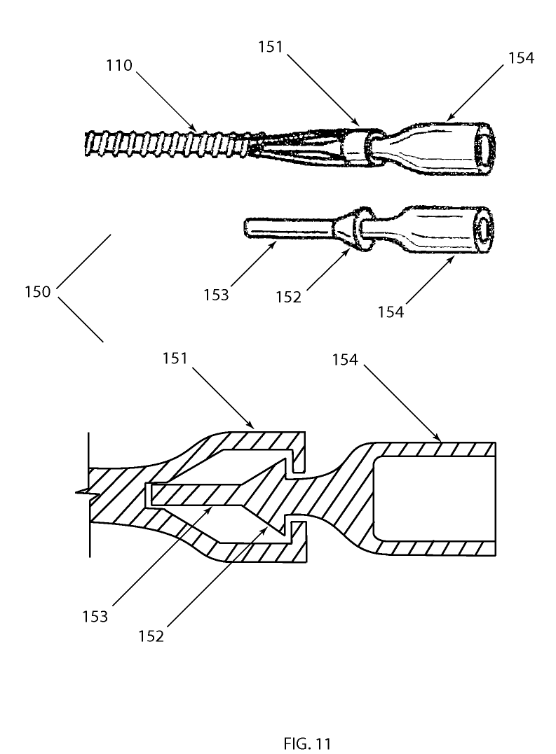

Eyeglass coupler 150 is yet another embodiment as shown and described in FIG. 11. Eyeglass coupler 150 embodies an inline sleeve 154 coupler that is releasable and interchangeable with similar couplers 150 having different sleeve sizes. Eyeglass coupler 150 includes, an eyeglass frame coupling sleeve 154, an insertion stem 153 and a key lock 152. Coupler 150 works in correlation with an elongated retainer cord 110 having a socket attachment end 151. Attachment is accomplished by inserting the insertion stem 153 of coupler 150 into the socket 151 of the elongate cord 110 and pressing together until the key lock 152 is fully engaged in the socket. The embodiment of the modular retainer and coupling system 1000 including frame coupler 150 eliminates the plurality of inter-coupling members 120 required for coupling the elongate cord 110 with the frame coupler 150.

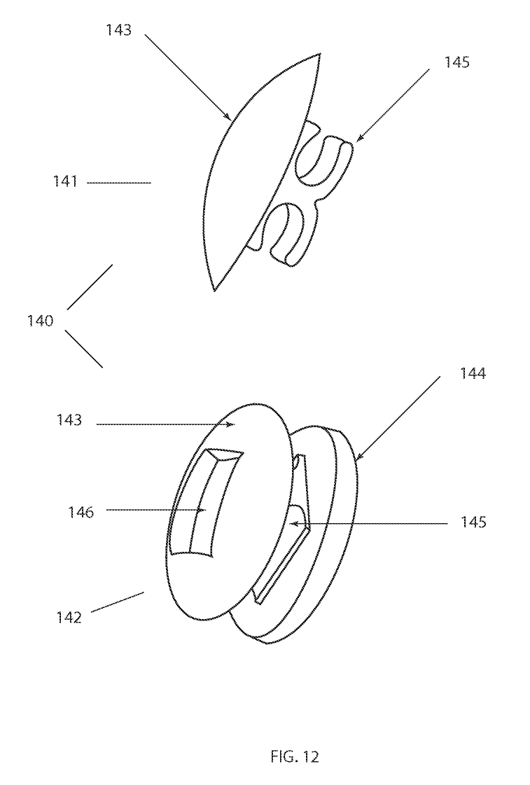

Medial connection device 140 is shown and described in FIG. 12. In one embodiment, medial connection device 141 includes a top portion 143, which may be formed in any shape, functional or purely ornamental, and an attachment portion 145 for engaging and attaching to an elongate cord 110 of the modular retainer and coupling system 1000. In one embodiment the attachment portion 145 includes holes allowing the ends of elongate cord 110 to be passed through. In a another embodiment the attachment portion 145 includes clips or slots allowing the medial connection device to be installed on the elongate cord 110 without removing or uncoupling any of the other installed components. In yet another embodiment, the medial connection device 142 is formed having a top half 143 and bottom half 144. Attachment to elongate cord 110 is accomplished by placing elongate cord 110 into the attachment portion 145, between the top half 143 and the bottom half 144, and releasably attaching the top half 143 and bottom half 144 together. Any surface of medial connection device may include information or ornamentation 146. Medial connection device 140 can be configured in any suitable shape, including simple shapes such as disc, hemisphere, square, rectangle, or oval or may be a complex relief such an arrowhead, alligator or tiger.

In view of the foregoing, those having ordinary skill in the relevant art will appreciate the advantages provided by the features of the present disclosure.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A modular retainer and coupling system comprising:
an elongate cord having a first attachment portion on a first end and second attachment portion on a second end;
a plurality of eyeglass frame couplers having an attachment portion;
one of the plurality of the eyeglass frame couplers releasably attached to the first attachment portion of the elongate cord;
another of the plurality of eyeglass frame couplers releasably attached to the second attachment portion of the elongate cord.

2. The modular retainer and coupling system of claim 1, wherein the plurality of eyeglass frame couplers includes a frame connection sleeve.

3. The modular retainer and coupling system of claim 2, wherein the frame connection sleeve is composed of an elastomeric material.

4. The modular retainer and coupling system of claim 2, wherein the frame connection sleeve of the plurality of eyeglass frame couplers are different diameters.

5. The modular retainer and coupling system of claim 1, including a plurality of inter-coupling members.

6. The modular retainer and coupling system of claim 5, wherein the inter-coupling members are one of an s-hook and a c-clip.

7. The modular retainer and coupling system of claim 5, wherein one of the plurality of the eyeglass frame couplers is releasably attached to the first attachment portion of the elongate cord using one of the plurality of inter-coupler members.

8. The modular retainer and coupling system of claim 1, including a plurality elongate cords and a plurality of inter-coupler members.

9. The modular retainer and coupling system of claim 8, wherein each elongate cord having a first attachment portion on a first end and second attachment portion on a second end.

10. The modular retainer and coupling system of claim 9, wherein the first attachment portion of one of the plurality of elongate cords is coupled to the second attachment portion of the same elongate cord using one of the plurality of inter-coupler members.

11. The modular retainer and coupling system of claim 9, wherein the first attachment portion of a first one of the plurality of elongate cords is attached to the first attachment portion of a second one of the plurality of elongate cords using a first one of the plurality of inter-coupler members, and the second attachment portion of the first one of the plurality of elongate cords is attached to the second attachment portion of the second one a plurality of elongate cords using a second one of the plurality of inter-coupler members.

12. The modular retainer and coupling system of claim 1, including a medial connection device configured for receiving a plurality of portions of the elongate cord therein.

13. The modular retainer and coupling system of claim 12, wherein the medial connection device having a decorative design.

14. The modular retainer and coupling system of claim 1, wherein the attachment portion the elongate cord receives a protrusion therein such that the protrusion is substantially encapsulated by the attachment portion.

15. A method of using a modular retainer and coupling system comprising:
providing a modular retainer and coupling system comprising an elongate cord, having an attachment portion on the first end, and an attachment portion on the second end, and a plurality of eyeglass frame couplers;
releasably attaching one of the plurality of eyeglass couplers to the attachment portion of the first end of the elongate cord and releasably attaching one of the plurality of eyeglass couplers to the attachment portion of the second end of the elongate cord.

16. The method of claim 15, including providing a plurality of inter-coupler members.

17. The method of claim 16, including releasably attaching one of the plurality of eyeglass couplers to the attachment portion of the first end of the elongate cord using one of the plurality of inter-coupler members and releasably attaching one of the plurality of eyeglass couplers to the attachment portion of the second end of the elongate cord using one of the plurality of inter-coupler members.

18. The method of claim 16, including providing a plurality of pairs of eyeglass frame couplers having an elastic connection sleeve, the elastic connection sleeve of each pair of the plurality of pairs of eyeglass frame couplers having a different diameter.

19. The method of claim 18, including providing a pair of eyeglasses having an earpiece of a certain size on each of two eyeglass temples and selecting the pair of eyeglass frame couplers having an elastic connection sleeve with the proper diameter to securely fit the earpiece of a certain size.

20. The method of claim 19, including releasably coupling one of the selected eyeglass frame couplers to the attachment portion of the first end of the elongate cord, releasably coupling a second one of the selected eyeglass frame couplers to the attachment portion of the second end of the elongate cord, releasably attaching a first one of the selected eyeglass frame couplers to a first one of the eyeglass earpieces by expanding the elastic connection sleeve over a end portion of the first eyeglass earpiece causing the elasticity of the connection sleeve to releasably engage the first eyeglass earpiece and releasably attaching the second one of the selected eyeglass frame couplers to the second one of the eyeglass earpieces by expanding the elastic connection sleeve over a end portion of the second eyeglass earpiece causing the elasticity of the connection sleeve to releasably engage the second eyeglass earpiece.
